(19) United States
(12) Patent Application Publication
(10) Pub. No.: US 2020/0037034 A1
(43) Pub. Date: Jan. 30, 2020

(54) System and Method for Navigating in a Digital Environment

(71) Applicant: Eben-Haeser Greyling, Hout Bay (ZA)

(72) Inventor: Eben-Haeser Greyling, Hout Bay (ZA)

(21) Appl. No.: 16/491,354

(22) PCT Filed: Mar. 2, 2018
(86) PCT No.: PCT/IB2018/051341

§ 371 Date: Sep. 5, 2019

(30) Foreign Application Priority Data
Mar. 9, 2017 (ZA) 2017/01697
Mar. 9, 2017 (ZA) 2017/01698
Mar. 9, 2017 (ZA) 2017/01699

(51) Int. Cl. H04N 21/4725; H04N 21/414; H04N 21/472; H04N 21/8549; H04N 21/858; H04N 21/431

(52) U.S. Cl. CPC H04N 21/4725; H04N 21/41407; H04N 21/4316; H04N 21/8549; H04N 21/858; H04N 21/47217

(57) ABSTRACT

A system (100) and method for navigating in a digital environment. The method includes providing a playback region on a display associated with an electronic device (112, 114, 116, 118) and providing a preview screen in the playback region prior to and/or after playback of a primary video. The playback region is divided into multiple secondary preview sections, and each section is selectable and represents a link to a location which may be associated with the primary video. A play button is provided and associated with the primary video. If a user selects the play button, the primary video is played. If a user selects a secondary preview section, navigation to the link of the secondary preview section is performed.

### CROSS-REFERENCES TO RELATED APPLICATIONS

This application claims priority from South African provisional patent application numbers 2017/01697, 2017/01698 and 2017/01699, all filed on 9 Mar. 2017 and which are incorporated by reference herein.

### FIELD OF THE INVENTION

This invention relates to a system and method for navigating in a digital environment, particularly for navigating to content related to a video file. The invention further relates to a method for generating a video file and a method for sharing digital content.

### BACKGROUND TO THE INVENTION

Browsing in an Internet environment may be cumbersome to a user, particularly when a user views a video file and wishes to navigate to related content, for example to related information pages or related video files accessible over the Internet.

Hyperlinks may be displayed during playback of a video which may allow a user to navigate to related or desired videos or web pages, but this may be disruptive to a user as it often blocks the video display and may be difficult to select or to dismiss. While a webpage on a desktop browser may display related content adjacent to or near a played video, the same is often not possible in a mobile browsing environment where a video is typically played in a full screen mode. On a mobile browser, a user may need to navigate on a mobile browser by panning or scrolling after browsing a video to reach hyperlinks that may lead to different web pages having the information of interest thereon. This may be cumbersome for a user and is clearly undesirable.

Additionally, locating desired links to related web content may be difficult for a user, particularly given that different websites or plugins generally have different layouts, resulting in that users may need to get used to different environments when browsing video content.

There is therefore a need for a system and method for navigating in a digital environment that alleviates the abovementioned problems, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a computer-implemented method performed on an electronic device and including the steps of:
providing a playback region on a display associated with the electronic device;
providing a preview screen in the playback region prior to and/or after playback of a primary video, the playback region being divided into multiple secondary preview sections, each section being selectable and representing a link to a location;
providing a play button associated with the primary video;
responsive to receiving a selection of the play button, playing the primary video; and
responsive to receiving a selection of a secondary preview section, navigating to the link of the secondary preview section.

Further features provide for the links to be selected from the list comprising: a video captured at the same location or of the same scene as the primary video and with a different camera; a list of videos associated with a same user profile that is associated with the primary video; a list of videos associated with the primary video due to a related genre, location or the like; access to individual frames or photos forming part of the primary video or being associated with the primary video; a location associated with the primary video; a website associated with the primary video; advertising content associated with the primary video; and a link to tags associated with the primary video.

Still further features provide for the playback region to be a region provided on a screen of an electronic device or to be an entire display of an electronic device; and for the display to be a user interface of the electronic device.

A yet further feature provides for the number of secondary preview sections provided in the playback region to be six.

A further feature provides for the method to include the step of, responsive to a selected secondary preview section representing a further video, displaying the further video in the playback region.

A still further feature provides for the display to be a touch-sensitive display of the electronic device, and for a selection from the user to be received via the touch-sensitive display.

Yet further features provide for the method to form part of a digital land ownership model wherein a real-world location has an equivalent digital location; and a geolocation is associated with the primary video, the digital location being associated with or owned by a digital land owner.

The method may include one or more of the steps of: capturing a primary video; receiving, from the user, an indication of a genre of the captured video; recording a geolocation at which the video is captured; receiving, from the user, tags to be associated with the primary video; and receiving, from the user, an indication of the secondary preview sections to be shown before or after playback of the primary video.

The step of receiving an indication of the secondary preview sections to be shown before or after playback of the primary video may include the user selecting any one or more advertisers, or group of advertisers, that may advertise in any one or more of the secondary preview sections. A list of advertisers from which a user may select advertisers may be filtered based on advertiser input in the form of an indication of genres of videos, geolocations of videos, or users they wish to advertise with. Users may be selected based on their online reputation or rating. Advertisers may be able to bid for placement pairing with specific themes and genres via a specifically provided advertising portal.

An advertiser may reward a user for playback of their video by another viewer and associated display of their advertising on the secondary preview section, and a digital land owner of the geographic location at which such video was captured may be similarly rewarded. Advertisers may also reward a viewer of the video and/or advertisement.

The invention extends to a method for creating a multimedia video file, the method performed on an electronic device and facilitated by an application operating on the electronic device, the method including the steps of:
receiving, from a user and via a user interface of the application, a selection of a media format to be captured;
capturing, using a camera associated with the electronic device, the selected media format;
combining all formats of captured media into a video file;
associating tags with the video file, the tags describing features of the video file and enabling categorization of video files having shared associated tags at a media platform; and
publishing the video file to the media platform.

Further features provide for the method to include the steps of: receiving a description of the video file from the user; generating tags based on the description provided by the user; and optionally allowing the user to edit the tags.

A still further feature provides for the media format to be a video format or a photo format.

Further features provide for the video file to be of a predetermined length; for the method to include the steps of: displaying the used and remaining time of the predetermined length on a progress bar during media capture; and, responsive to the captured media format reaching the predetermined length, terminating the capturing of media.

Still further features provide for a captured photo to be displayed for a predetermined segment of the video file, for example as 1 second, 2 seconds, or the like of the predetermined length; and for the predetermined segment to be displayed in the progress bar during creation on a video file.

Yet further features provide for the step of generating tags to include analysing the description provided by the user, scanning a database for pre-existing tags appearing in the description of the user, providing suggested tags based on the pre-existing tags in the database; and generating tags based on the description provided by the user.

Further features provide for the method to include the steps of: receiving a skin to be applied to the application facilitating operation of the method; receiving conditions to be met to activate custom operation of the application, the conditions being any one or more of a time and date and geographical area; receiving a preconfigured media platform to which a video file is to be published; and receiving predetermined tags to be associated with media files captured during custom operation of the application.

Still further features provide for the method to include the steps of: receiving a marker to activate an augmented reality mode of the application; analysing a scene viewed by the camera of the device; responsive to the marker appearing in the scene, activating the augmented reality mode and generating a predetermined animated item onto a preview display of the scene shown on a display of the electronic device; responsive to a user selecting a media format to be captured whilst the animated item is displayed on the preview display, including the predetermined item in the captured media format as it is displayed on the preview display; and publishing the video file to a preconfigured portal.

The marker may be any suitable identifier known in the art, such as a barcode, image, item or person, and the predetermined item may be a computer-generated image, video file or the like overlaid onto the scene.

The skin, conditions, marker and predetermined animated item may form part of the application at an initial download thereof, and may be configured to be discarded when the condition are not met, or have expired, so that operation and appearance of the application reverts to a default mode. The skin, conditions, marker and animated item may be selectively downloaded by a user, or may be pushed to the user from a management portal managed by approved administrators.

A further feature provides for the method to include the step of editing the captured video file based on user-received instructions prior to publishing the file.

Yet further features provide for the method to include the step of receiving, from the user and via a user interface of the application, an indication of an augmented reality item to be inserted into the video; receiving, from the user and via a user interface of the application, an indication of where in the video the augmented reality item is to be displayed; displaying the augmented reality item in the preview display; and capturing the augmented reality item with the captured media format as it is displayed in the preview display.

The invention extends to a computer-implemented method for sharing digital content, the method conducted at an electronic device and comprising the steps of:
providing a user of the electronic device with at least one selectable category, the category defining at least a platform to which an item of digital content is to be published,
receiving a selection of a category from the user via a user interface of the electronic device,
capturing an item of digital content which the user wishes to publish, and
publishing the item of digital content on the platform defined by the selected category.

A further feature provides for each category to include tags to be added to an item of digital content, the tags linking the item of digital content to a user or group on the platform.

Further features provide for the category to be set up by the user, and for the method to include the step of receiving, from the user, configuration settings for the category; for the configuration settings to include a platform to which an item of digital content is to be published; and for the configuration settings to include a tag to be added to the item of digital content.

The platforms may be any one or more of a messaging platform, a social media platform, an advertising platform, a website, and the like. The item of digital content may be any publishable digital item, for example an image, an audio file such as a voice note, a text message or post containing text, or the like, but preferably a video file.

A yet further feature provides for the method to include the step of transmitting the item of digital content to a remote server for further publication by the remote server.

Still further features provide for promoted categories to be configured by an external party, and for the method to include the step of receiving, from a remote server associated with the external party, the promoted categories, each promoted category associated with a campaign managed by the external party and defining a set of conditions defining when the promoted category is available for selection by the user.

The set of conditions may include, that the time of day or date falls within a specific time period, that the electronic device is in a specific geographical area, that a specific physical use of the device has occurred, or the like.

An even further feature provides for the promoted categories to include a platform to which the item of digital content is to be published and/or a tag which is to be added to a captured item of digital content.

The invention extends to a system for navigating in a digital environment, the system including an electronic device including a memory for storing computer-readable program code and a processor for executing the computer-readable program code having:
a playback region component for providing a playback region on a display associated with the electronic device;
a preview screen component for providing a preview screen in the playback region prior to and after playback of a primary video,
a play button component for providing a play button associated with a primary video in the playback region,
a preview section component for dividing the playback region into multiple secondary preview sections, each section being selectable and representing a link to a location;
a playback component for, responsive to receiving a selection of the play button, playing the primary video; and
a navigation component for, responsive to receiving a selection of a secondary preview section, navigating to the link of the secondary preview section.

Further features provide for the system to include a video creation component for facilitating the creation of videos; and for the system to include a publishing platform selection component for selection platforms to which a created video is to be published.

Still further features provide for the system to include a geolocation component for capturing a geolocation where a video is captured, the geolocation corresponding to a digital location being associated with or owned by a digital land owner.

Yet further features provide for the system to include a genre receiving component for receiving, from the user, an indication of a genre of the captured video; a tag component for generating or for receiving, from the user, tags to be associated with the primary video; and a secondary preview section receiving component for receiving, from the user, an indication of the secondary preview sections to be shown before or after playback of the primary video.

Further features provide for the system to include an advertiser selection component to allow a user to select any one or more advertisers, or group of advertisers, that may advertise in any one or more of the secondary preview sections, and for the advertiser selection component to be configured to allow advertisers to bid for placement pairing with specific themes and genres via a specifically provided advertising portal.

The invention further extends to a computer program product for navigating in a digital environment, the computer program product comprising a computer-readable medium having stored computer-readable program code for performing the steps of:
providing a playback region on a display associated with the electronic device;
providing a preview screen in the playback region prior to and/or after playback of a primary video, the playback region being divided into multiple secondary preview sections, each section being selectable and representing a link to a location;
providing a play button associated with the primary video;
responsive to receiving a selection of the play button, playing the primary video; and
responsive to receiving a selection of a secondary preview section, navigating to the link of the secondary preview section.

The invention extends to a computer program product comprising a computer-readable medium having stored computer-readable program code for performing the steps of:
receiving, from a user and via a user interface of an application facilitating operation of the method, a selection of a media format to be captured;
capturing, using a camera associated with the electronic device, the selected media format;
combining all formats of captured media into a video file;
associating tags with the video file, the tags describing features of the video file and enabling categorization of similar video files at a media platform; and
publishing the video file to the media platform.

According to another aspect of the present invention there is provided a computer program product for sharing digital content, the computer program product executable at an electronic device comprising a computer-readable medium having stored computer-readable program code for performing the steps of:
providing a user of the electronic device with at least one selectable category, the category defining at least a platform to which an item of digital content is to be published,
receiving a selection of a category from the user, via a user interface of the electronic device,
capturing an item of digital content which the user wishes to publish, and
publishing the item of digital content on the platform defined by the selected category.

The computer-readable medium may be a non-transitory computer-readable medium and the computer-readable program code may be executable by a processing circuit.

Embodiments of the invention will now be described, by way of examples only, with reference to the accompanying drawings.

### BRIEF DESCRIPTION OF THE DRAWINGS

In the drawings:

FIG. 1 is a schematic diagram of an exemplary system in which several electronic devices according to invention may be used;

FIG. 2 is a flow diagram illustrating an exemplary method for navigating in a digital environment;

FIG. 3 shows a mobile device on which a playback region according to an exemplary embodiment of the invention is provided;

FIG. 4 shows the mobile device of FIG. 3 when playback may be paused;

FIG. 5 shows the mobile device of FIG. 3 after playback has been paused;

FIG. 6 shows a display of a personal computer with a playback region according to the invention displayed thereon;

FIG. 7 is a block diagram which illustrates an exemplary system for navigating in a digital environment;

FIG. 8 is a flow diagram illustrating showing an exemplary embodiment of a method according to the the present invention;

FIG. 9 shows a playback region in which preview sections according to another exemplary embodiment the invention may be displayed;

FIG. 10 is a schematic diagram of a further exemplary system in which aspects of the invention may be implemented;

FIG. 11 is a flow diagram illustrating an exemplary method for creating a multimedia video file according to further feature of the invention;

FIG. 12 is a flow diagram illustrating an exemplary method for defining custom operation of an application facilitating operation of the invention according to a further feature of the invention;

FIG. 13 is a swim lane flow diagram of a method for sharing digital content according to a still further feature of the invention; and

FIG. 14 illustrates an example of a computing device in which various aspects of the disclosure may be implemented.

### DETAILED DESCRIPTION WITH REFERENCE TO THE DRAWINGS

The systems and method described herein provide a method for navigating in a digital environment, and is particularly suited to be used while viewing video files. At a preview screen of a video, often known to only display a thumbnail image from the video, a user may be allowed to view and select multiple related links at which further information related to the primary video may be available. The systems and methods may provide an application which may allow navigation according to the disclosed method, or the functionality may be incorporated into a known application.

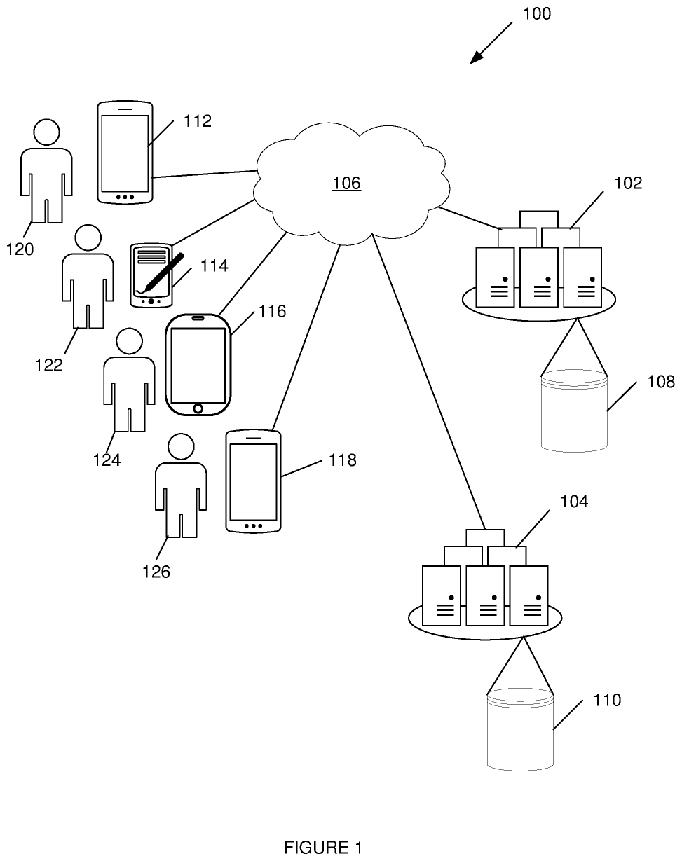

FIG. 1 shows a schematic diagram of a system in which several electronic devices according to invention may be used. A system (100) for navigating in a digital environment is shown. The system (100) includes a first server system (102) and a second server system (104) in communication with a plurality of electronic communication devices over a communication network, in the present embodiment the Internet (106). A first database (108) and a second database (110) is associated with the first server system (102) and the second server system (104), respectively. In the present embodiment, four electronic communication devices (112, 114, 116, 118) are shown, each communication device belonging to an associated user (120, 122, 124, 126). Although only four devices are shown, it is envisaged that a large number of device may be included in the system. Furthermore, although only two server systems and associated databases are shown, it is envisaged that a multitude of server systems may be provided. The present invention allows users (120, 122, 124, 126) to browse content hosted on the multiple server systems (102, 104) in a simplified manner from what is known. Related information may be provided to users before or after viewing a video file, which may allow the users to navigate to additional content without the need for extensive browsing to locate the content. This may reduce browsing time and provide a better browsing experience to a user.

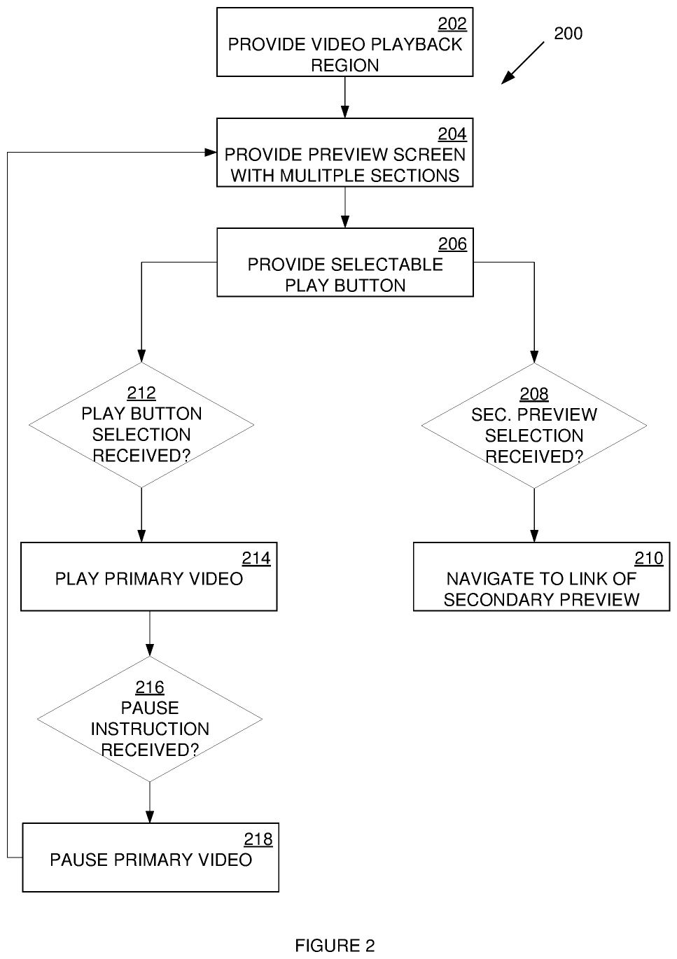

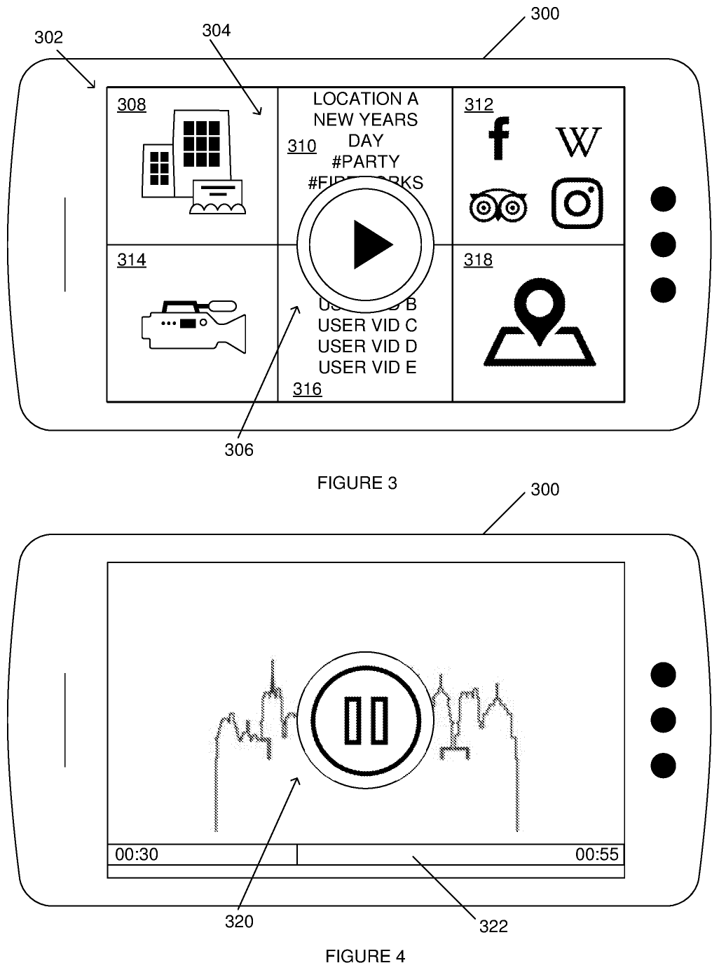

FIG. 2 shows a flow diagram (200) of an exemplary method for navigating a digital environment on an electronic device of a user. A playback region is first provided (202) on a display of the electronic device. In the present embodiment, the display is a touch-sensitive display of a mobile smartphone, which may function as a user interface and may be used to interact with the electronic device. FIG. 3 shows a mobile smartphone (300) including a playback region (302).

The playback region of the present embodiment extends across the entire screen of the smartphone (300). FIGS. 2 and 3 are described simultaneously further below.

When a primary video is ready to be displayed to a user, a preview screen (304) is provided (204) in the playback region (302). The video may be ready to be displayed to a user after its selection from a search engine, video hosting website, or the like as is known in the art. The smartphone (300) may be configured to display the preview screen before a primary video is played, and/or after a primary video has been played similar to how it is known in the art to display a thumbnail image before and after a video has been played. It is envisaged that the preview screen may also be displayed when playback of the primary video has been paused.

The preview screen includes multiple secondary preview sections, in the present embodiment six secondary preview sections. Each secondary preview section is selectable, and represents a link to content related to the primary video. A play button (306) is provided (206) and displayed in the preview screen, and is explained further below.

In the present embodiment, the primary video includes still images or photos which are displayed as a part of the video. A first secondary preview section (308) of the present embodiment is associated with a link where these images or photos may be individually viewed. A thumbnail image of such an image is shown in the first preview section (308). The images may be displayed in the same playback region. Alternatively the link of the first secondary preview section may cause the electronic device to navigate to a webpage or the like at which the images may be displayed in any manner known in the art, whether as part of a plugin through which a user may browse, or to a page where all the photos are simultaneously loaded and scrolling is required to view the images individually.

A second preview section (310) is associated with tags that may be used to describe content of the primary video. In the present embodiment, the tags describe a location, presently “Location A”, an event forming the subject of the video, presently “New Year's Day”, and aspects of the event, namely “#party” and “#fireworks”. It should be noted that the tags are at least partially obscured by the play button (306), which is provided preference on the display of the smartphone. A list of these tags may be viewed at the link associated with the second preview section, and may be individually selectable at that link to allow further navigation to lists of content where other videos with similar tags may be accessed and viewed. It will be apparent to a person skilled in the art that any suitable tags may be provided and may be associated with the primary video, and may depend on numerous different aspects of the video.

A third preview section (312) includes icons of several content providers. The icon may be individually selectable, and may be configured such that each of the icons provide a link to a specific website at that content provider and which is related to the video. If, for example, the primary video is of a specific historic site, an icon of the online encyclopedia “Wikipedia™” may represent a link to the Wikipedia™ entry for that historic site. Additionally, if a TripAdvisor™ entry of the historic site is available, an icon of TripAdvisor™ may link to the relevant description of the site on TripAdvisor™. In the present embodiment, a Wikipedia™, Facebook™, TripAdvisor™ and Instagram™ icon is shown in the third preview section (312). It is also envisaged that the icons may not be individually selectable, but that selection of the third preview section may bring up a list or the like of possible third party websites to which a user may select to navigate to.

A fourth preview section (314) includes a thumbnail image of a video taken at the same time and at the same scene as the primary video. In the present embodiment, the primary video has been captured with a primary, rear-facing camera of a smartphone, and a video captured at the same time and with a second, forward-facing camera of the same smartphone is associated with the fourth preview section. Selection of the fourth preview section (314) may cause the second video to play in the playback region (302).

A list of videos associated with a same user profile as that of the present, primary video may be provided in a fifth preview section (316). In the present embodiment, “USER VID B”, “USER VID C, “USER VID D” and “USER VID E” are shown in the fifth preview section (316). Selection of the fifth preview section may provide a user with a complete list of videos of the present user profile, and these videos may then be individually selectable to navigate thereto and play the selected video. It is envisaged that videos in the fifth preview section may also be directly selectable where they are shown in the section to allow direct playing of the selected video in the playback region (302).

A sixth preview section (318) in the present embodiment provides a link to a map where a location at which the primary video was shot may be shown. Selection of the sixth preview section may open up and load a separate application which may display the location. A map icon is shown in the sixth preview section (318) of the present embodiment.

When any of the six preview sections are selected by a user, the smartphone receives (208) the selection, and navigates (210) to the link associated with the applicable secondary preview section. As discussed above, navigation may take on multiple forms depending on the type of section that has been selected. It may, for example, take the form of opening another video in the same preview screen, opening a web page with desired information, opening a list of items to be further selected from, opening an application providing the relevant information, or the like.

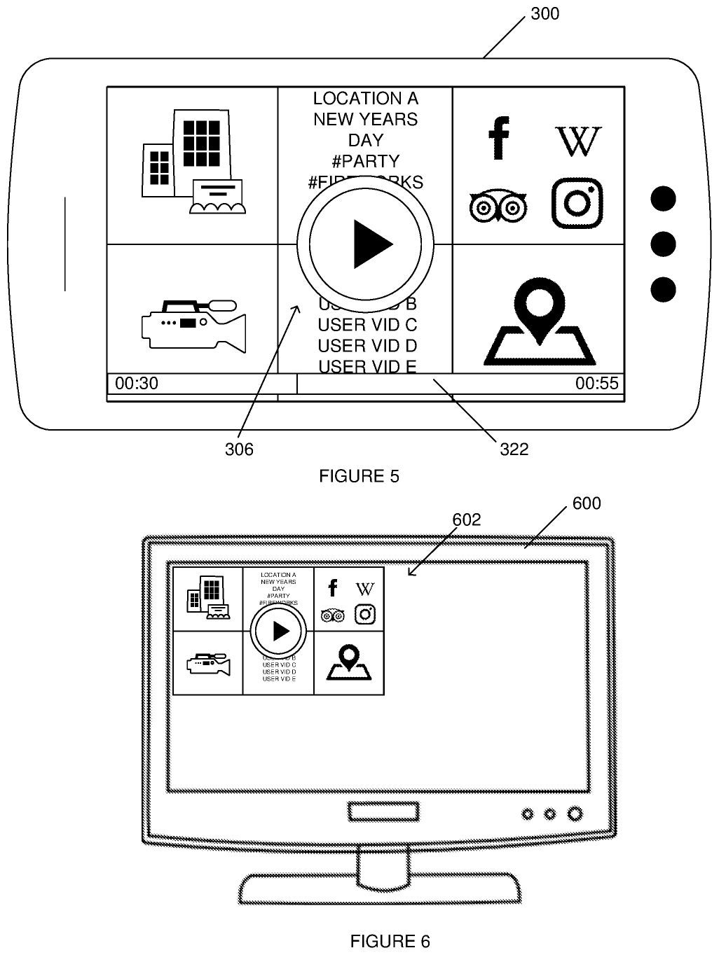

The play button (306) is associated with the primary video. When the play button (306) is selected by a user, the selection is received (212) by the smartphone, and the primary video is played (214) in the playback region. When a user pauses the video, for example by touching on the touch-sensitive display on which the video is displayed, and selecting a pause icon that appears on the screen afterwards, the user may again be provided with the original preview screen with multiple secondary preview sections and a play button. FIG. 4 shows a display where a user has touched the touch-sensitive display during playback of the primary video and a pause icon (320) is displayed, and FIG. 5 shows a display where the smartphone has received (216) a pause instruction, and the primary video has been paused (218).

It should be noted that the preview screens of FIGS. 4 and 5 now include a progress bar (322) which indicates how much time of the primary video has lapsed, and how much time remains.

When a user again selects the play button (306) on the screen of FIG. 5, the video continues playing at the present location as indicated in the progress bar.

When playback of a video has been completed and the video has stopped, the user may again be provided with the original preview screen as shown in FIG. 3. Selection of the play button (306) may then restart playback of the primary video from its beginning.

FIG. 6 shows an exemplary embodiment of the invention where a display (600) of a personal computer is used to display a playback region (602) according to the embodiment. It will be apparent that the playback region need not take up an entire display associated with an electronic device, but that only a small region of the display need to be used. The user may interact with the playback region in any suitable way, for example via a computer mouse in communication with the display of FIG. 6. A touch-screen display is not required for operation of the method. It is envisaged that the pause button may be displayed over the video when a pointer operated by a computer mouse is moved across the playback region (602).

It is envisaged that any number of secondary preview sections may be provided. While only 6 sections are described above, any suitable number may be provided, and the number may be determined by various factors, such as available categories, a size or resolution of the playback region, or the like. Similarly, while only six specific related links are mentioned above, it will be apparent to a person skilled in the art that many other types of related links may be provided. As examples, the links may include any one or more of a video captured at the same location or of the same scene as the primary video and with a different camera, a list of videos associated with a same user profile that is associated with the primary video, a list of videos associated with the primary video due to a related genre, location or the like, access to individual frames or photos forming part of the primary video or being associated with the primary video (for example a selfie or video taken with another camera at the same time as the primary video), a location associated with the primary video, a website associated with the primary video, advertising content associated with the primary video, a link to tags associated with the primary video, and a live streaming video. A person skilled in the art will appreciate that any Application Programming interface (API) functionality may be provided in one of the secondary preview sections.

Additionally, while only an Internet-based navigation environment is described above, it is envisaged that the described systems and methods may be used in a format of browsing in any digital environment, for example on an internal network, or even browsing on a local device storage.

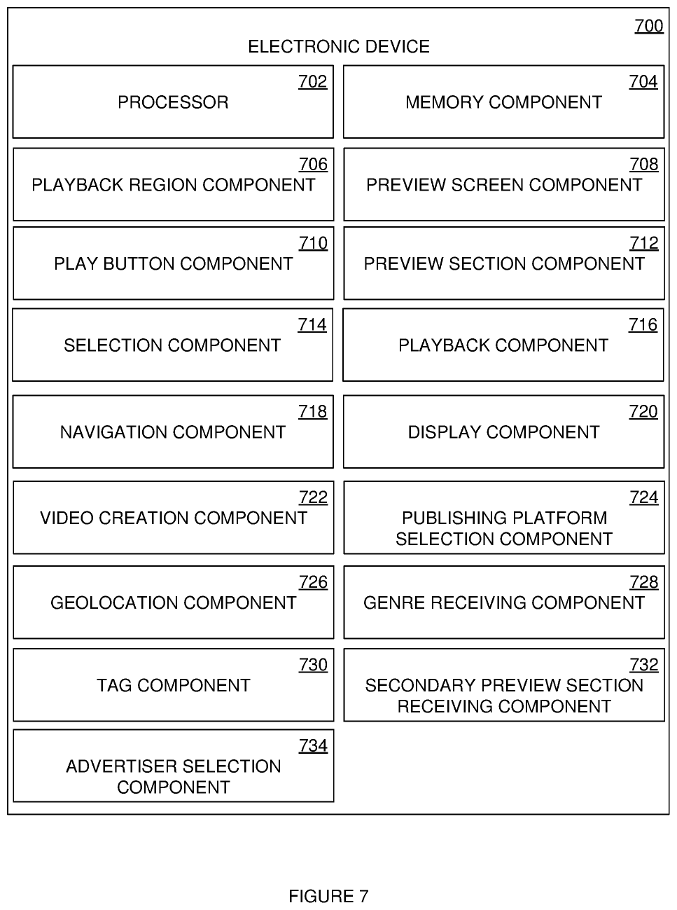

FIG. 7 shows logical components of an exemplary electronic device (700) housing a system for browsing in a digital environment according to an exemplary embodiment of the invention. The electronic device may be any electronic device typically used to browse in a digital environment, such as a mobile phone, wearable electronic device, tablet computer, laptop computer, personal computer, or the like. It is envisaged that it may often be a communication device that a user normally has in their possession. The electronic device (700) may include a processor (702) for executing the functions of components described below, which may be provided by hardware or by software units executing on the electronic device (700). The software units may be stored in a memory component (704) and instructions may be provided to the processor (702) to carry out the functionality of the described components. In some cases, for example in a cloud computing implementation, software units arranged to manage and/or process data on behalf of the electronic device may be provided remotely. Some or all of the components may be provided by a software application downloadable onto and executable on the electronic device.

The electronic device includes a playback region component (706) arranged to provide the playback region on a display associated with the electronic device and a preview screen component (708) arranged to provide the preview screen in the playback region prior to and after playback of a primary video.

A play button component (710) is provided and arranged to provide the play button associated with the primary video in the playback region, and a preview section component (712) is provided and arranged to divide the playback region into the multiple secondary preview sections. As described above, each section is selectable and represents a link to a location. The location may be associated with the primary video, but may be so associated purely because of its appearance at the primary video.

A selection component (714) is provided and arranged to receive selections performed by a user, and a playback component (716) is provided and arranged to play the primary video in response to receiving an appropriate playback instruction from the user, generally selection of the play button. A navigation component (718) is provided and arranged to navigate to a link associated with a secondary preview section responsive to receiving an appropriate selection from the user.

A display component (720) may also be provided and may be arranged to display the required information on the display of the electronic device.

A video creation component (722) is arranged to facilitate the creation of videos, and a publishing platform selection component (724) is arranged to allow a user to select platforms to which a created video is to be published. A geolocation component (726) is arranged to capture a geolocation where a video is captured, the geolocation corresponding to a digital location being associated with or owned by a digital land owner.

A genre receiving component (728) is arranged to receive, from the user, an indication of a genre of the captured video, a tag component (730) is arrange to generate or receive, from the user, tags to be associated with the primary video, and a secondary preview section receiving component (732) is arranged to receive, from the user, an indication of the secondary preview sections to be shown before or after playback of the primary video.

An advertiser selection component (734) may also be arranged to allow a user to select any one or more advertisers, or group of advertisers, that may advertise in any one or more of the secondary preview sections associated with the video.

It will be apparent to a person skilled in the art that some of the functionality that may be performed by the electronic device may in fact be done remotely on a server system, such as the server systems (102, 104) of FIG. 1. As a result, some of the components found on the electronic device of FIG. 7 may be found at a server system, with the Internet providing the required communications link between an electronic device and the relevant server system.

The present invention may therefore provide a navigation environment which is easier to navigate, and which may result in a reduced time for a user to locate desired information. Links to related information may be more readily locatable to a user, reducing or eliminating the need for additional browsing outside of a video playback region. Operation of the same playback region across multiple platforms may prove more familiar to a user, resulting in additional ease of navigation.

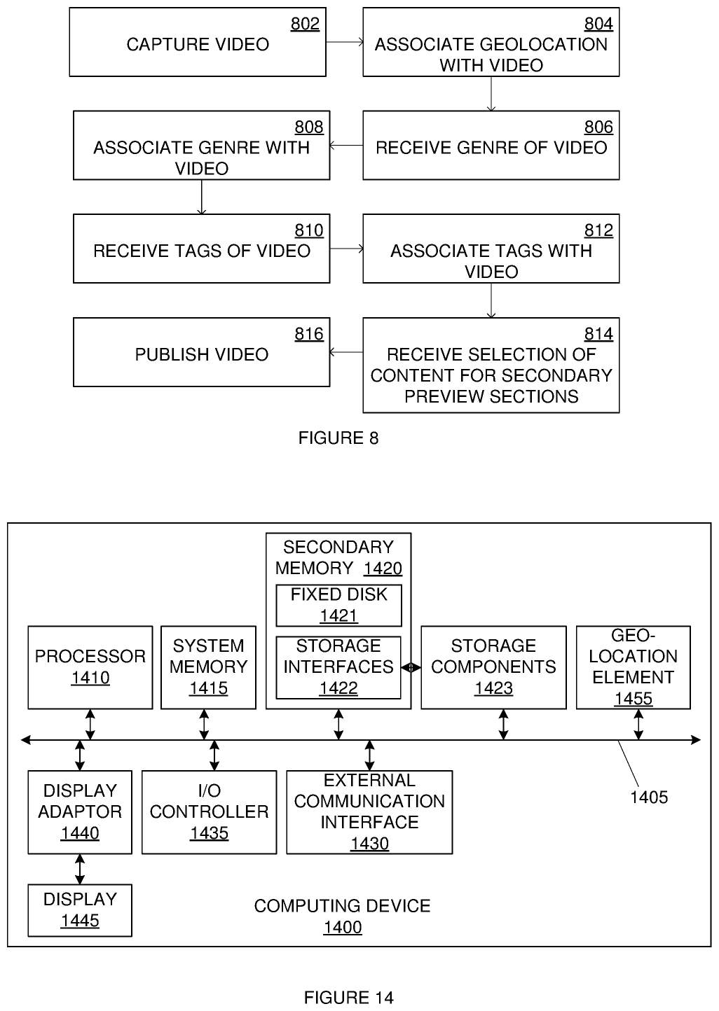

FIG. 8 illustrates a flow diagram (800) showing a specific implementation of the present invention. In this embodiment, the invention is implemented as part of a digital land ownership model, wherein an advertisement associated with a video may lead to a reward for the creator of the video and a digital land owner who owns the geographic location at which the video was captured. This may be implemented as part of a video platform. The flow diagram (800) illustrates a method performed on an electronic device.

First, a video is captured (802). It should be noted that “capturing” a video may be done using a specific application facilitating operation of the method, or may include importing the video from any other location or application. The geolocation of the video may be manually associated (804) therewith, or may automatically be recorded and will in such case automatically be associated (804) therewith. The geolocation component (726) of FIG. 7 may be arranged to provide this functionality. A user provides a genre of the video, which is received (806) by the electronic device and is associated (808) with the video. The genre receiving component (728) of FIG. 7 may be arranged to provide this functionality. Additionally, tags may be provided by a user and received (810) by the electronic device, and may then also be associated (812) with the video. The tag component (730) of FIG. 7 may be arranged to provide this functionality.

The user may then be allowed to select the content to be provided in each six secondary preview sections, which is received (814) by the electronic device. The secondary preview section receiving component (732) described with reference to FIG. 7 may provide this functionality. Thereafter, the electronic device may publish (816) the video to the appropriate platform.

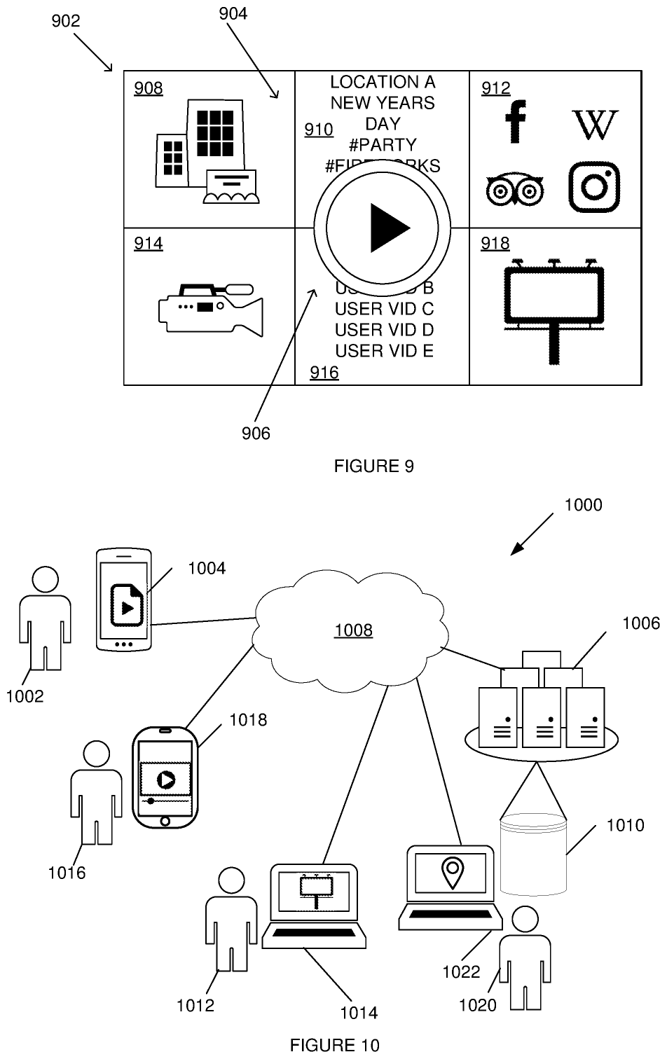

FIG. 9 shows a playback region (902) in which the preview sections of the present embodiment may be displayed. When a primary video is ready to be displayed to a user, a preview screen (904) is provided in the playback region (902). As described above with reference to FIG. 3, the video may be ready to be displayed to a user after its selection from a search engine, video hosting website, or the like as is known in the art.

The preview screen includes multiple secondary preview sections, in the present embodiment six secondary preview sections. Each secondary preview section is selectable, and represents a link to content related to the primary video. A play button (906) is also provided and is displayed in the preview screen (904).

In FIG. 9, the user has selected a static image of the video as the first secondary preview section (908), tags that may be used to describe content of the primary video as the second secondary preview section (910), icons of several content providers as the third secondary preview section (912), a thumbnail image of a video taken at the same time and at the same scene as the primary video in the fourth secondary preview section (914), and a list of videos associated with a same user profile as that of the present video as the fifth secondary preview section (916). This corresponds to the first five preview sections as shown and described with reference to FIG. 3.

The sixth and final secondary preview section (918) is, in this embodiment, filled with an icon of an advertiser. A specific advertiser, or a group of advertisers, that are allowed by the user to advertise in association with their video may be selected in a specific manner. After an advertising field is chosen by the user as one of their secondary preview sections, the user may be provided with a list indicating a genre of advertisers. The user may be allowed to select “All advertisers”, which will not limit the possible advertisers from the user's side. Alternatively, the user may select, for example, “Vehicles”, which may allow only vehicle manufactures to advertise with your video. The genres may be as diverse or specific as desired. A user may be allowed to select one or more genres, or may be allowed to specifically exclude specific genres. Further selection within the genre may also be allowed, for example selection of a specific advertiser falling within the selected genre.

It will be apparent that a user may allow advertisers to occupy more than one of the secondary preview sections, in which case a user may be allowed to select a genre and/or a specific advertiser individually or at the same time.

Similar to how a user may select a genre and/or a specific advertiser, advertisers may also be allowed to determine where their advertising may be placed. For example, an advertiser may choose a genre of video content where they wish to display their advertising an advertiser may wish that their motorcycle advertisement be displayed in association with an extreme sports video, rather than with a documentary about flora. An advertiser may be allowed to create a geographically fenced area, or geo-fence, where their advertising content may be displayed. For example, a merchant located in a specific province may wish that only persons in that province be shown their advertising, rather than someone located remotely therefrom. In addition, advertisers may be allowed to prevent their advertisements from being shown with videos of users with low viewer ratings, which may be as a result of a user uploading quality videos, incorrect videos, or videos dealing with sensitive or controversial topics. An advertiser may also be allowed to geo-fence their advertisements by only making it display in relation to videos captured in a specific area for example, a travel company may only wish to advertise to persons viewing videos of remote locations.

A user will typically only be allowed to select an advertiser if the user meets the requirements set by the advertiser themselves.

Once a user has selected the details of the advertiser in the sixth secondary preview section, the video may be finally uploaded for viewing by other users of the platform.

When a video of a user is viewed, and the advertisement is displayed to or is selected and viewed by a viewer of the video, the user may be rewarded for such viewing by another person. This reward may be financial, typically in the form of a “micro-payment” as is known in the art. In the present embodiment, however, the invention form part of a digital land ownership model, as indicated above. As also mentioned above, all videos have geo-location data associated therewith. In a digital land ownership model, digital land is superimposed on the physical world, and may be owned by specific persons. The geolocation of a video may be used to identify an owner of the digital land that corresponds to the geo-location of the physical world. In the present embodiment, the owner of the digital land is also rewarded, due to them being the owner of the location at which the video was captured. The advertiser may therefore reward the creator (or poster) of a video and a digital land owner of the digital land corresponding to the geo-location at which the video was captured.

It is envisaged that the digital land ownership model forming part of the present invention may be a cryptocurrency-based platform. As a result, a creator and digital land owner may be rewarded in the form of cryptocurrency instead of fiat currency. The platform on which the present invention operates may be built on blockchain infrastructure, with the cryptocurrency tokens in which participants are able to transact on the blockchain infrastructure being used by advertisers to pay both digital land owners and creators of video as described above.

FIG. 10 shows a schematic diagram of a system (1000) wherein an advertiser and a digital land owner may be rewarded for viewing of an advertisement on a video platform provided by the invention.

A user (1002) creates and publishes a video using their mobile device (1004), as shown and described with reference to FIG. 8. The user's mobile device (1004) is in communication with a server system (1006) over a communications network, presently the Internet (1008). The server system facilitates operation of the present platform, including methods and systems forming part of the present invention, and includes a database (1010) on which published videos are stored. During the video creation process, a user has selected a specific advertiser (1012) which may advertise in one of the secondary preview sections associated with their video, as was described above. It will be apparent that the advertiser was selected after the criteria for selection they themselves have provided using their electronic device (1014).

Advertisers may be able to bid for placement pairing with specific themes and genres via a specifically provided advertising portal.

A viewer (1016) browses videos using their electronic device (1018), and locates the video of the user (1002).

Browsing of videos may be allowed on a purpose-provided video portal. This may include that the videos are presented as an overlay on a world map, enabling viewers to zoom in on specific locations. Additional filters may be selectable, for example age, size of a video, most popular, and the like. A viewers may then select the video they wish to watch. When selecting a video to watch, it may end with a display such as the one shown and described above in FIG. 9. This may also be shown prior to playing of the video.

Search, sharing, download, like, comment, rating of contributor, setting of location-based alerts, and flagging of inappropriate content may all be provided may all be provided by the video portal. Filters may be set up to automatically prevent undesirable content from being publically posted on the video platform. Viewers may be allowed to flag videos deemed undesirable, which may then finally be investigated and adjudicated on by operators of the platform. Repeat offenders may be blacklisted. In a situation where inappropriate or undesirable content does make it through any filters, advertisers may be allowed to immediately pull their advertising from such videos.

Before or after watching the video, the advertisement of the advertiser (1012) is displayed to the viewer. As a result of playing of the advertisement, the user may be rewarded, presently via a cryptocurrency token usable on the platform.

The video includes geographic information which indicates where the video was captured. The geographic information is accordingly stored with the video on the database (1010). As the present system involves digital land ownership, a digital version of the physical geographic location of the video is owned by a digital land owner (1020). It will be apparent that the land owner (1020) will require an electronic device (1022) to manage their ownership of the digital land. The advertiser then also rewards the digital land owner (1020) in return for them owning the digital land at which the video was captured.

In this manner, the present invention further provides a method for rewarding a digital land owner as a result of advertising related to a video captured at a geolocation for which they own the digital land associated therewith.

The above system and method allows video creators to enhance the value of their videos by bringing them into a blockchain-based infrastructure in which they may be rewarded by advertisers. Video creators may be allowed to set up a multitude of channels, each with their own privacy settings and themes. As an example, this may be social, news updates, commercial offerings, entertainment, and the like.

Advertisers become participants in an advertising system wherein they may target a group of viewers, specific creators or viewers with which they would like to be associated. They can target specific locations for their advertisements, but leave video creators with a final say regarding which advertisements are more likely to resonate with their audiences and therefore will be linked to their videos. Creators and viewers may be rewarded for viewing videos, possibly based on a number of times a video is viewed or the number of times that a viewer watches videos. The involvement of third parties that may in the past have been involved in targeting a specific audience may in the present invention be excluded. Viewers that are rewarded for watching videos may be so rewarded by advertisers themselves.

Digital land owners may purchase digital land areas in the form of geo-spatial zones, and may promote specific location on the platform to advertisers. Suitable promotion may lead to a reward for videos taken at that location and viewed by others.

It is envisaged that digital land ownership will be recorded on blockchain infrastructure. Cryptocurrency tokens associated with the system may allow a person to purchase a piece of digital land associated and overlaid onto physical coordinates. Digital land may be available as hexagonal plots of approximately 300 square meters. Hexagonal plots may be provided over the entire physical world. The blockchain infrastructure may be Ethereum infrastructure. As part of an Initial Coin Offering (ICO), participants may purchase cryptocurrency tokens and may acquire land which they wish to obtain. Logging details of land ownership on blockchain infrastructure may ensure transparency and integrity of transactions. At a start-up phase, plots may be purchased from the platform facilitating operation of the digital land ownership model. Thereafter, plots may be traded between individuals, typically by paying therefore in the applicable cryptocurrency usable on the system. Owners of digital land may be allowed to access graphical, dashboard-style reports concerning their owned plots, access videos and related metrics, and track revenues generated over time on a custom dashboard.

Land ownership, as well as the status thereof, transactions relating thereto, and proof of ownership and transactions may be managed by a decentralized smart contract lodged on the applicable blockchain platform. This may further enhance transparency.

The invention may involve the provision of a portal that graphically represents video on a global map according to where they were created. Creators of videos may be allowed to convert uploaded videos into the unique format as described above, wherein the multiple secondary preview sections form part of the display thereof.

The platform may allow for chat functionality between users, in the form of chatrooms or the like to be provided to users. Additionally, token and/or cryptocurrency payments or transfers between users may be allowed. Such payments or transfers may take place between electronic wallets, for example cryptocurrency wallets, of any suitable type.

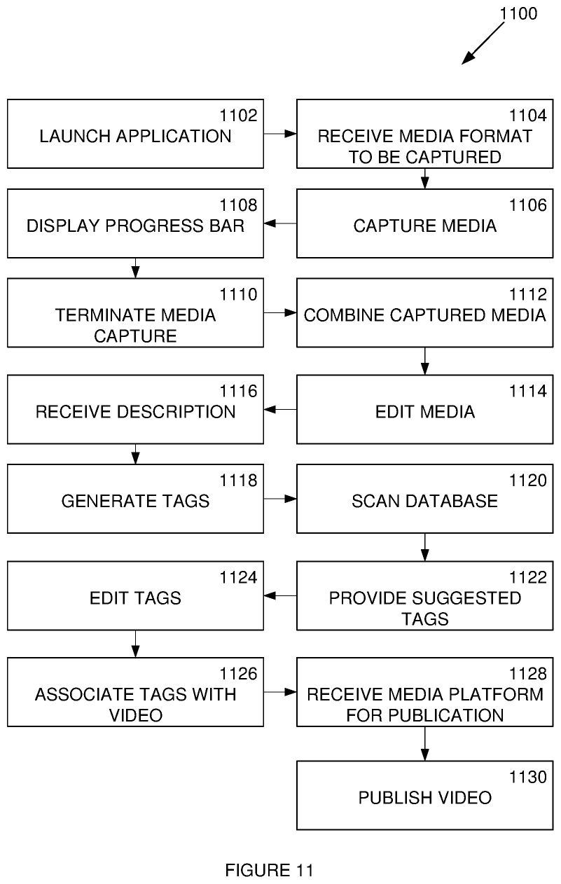

FIG. 11 shows a method (1100) of creating a media file according to an additional feature of the invention as it is performed on an electronic device. This method may be used when a user wishes to advertise an item for sale on a media platform. A user launches (1102) an application facilitating operation of the method and is provided with a preview screen showing what a camera of the electronic device is able to capture. The user then selects a media format that they wish to capture, typically a photo or a video. The selection of the media format is received (1104) by the application. The user may intermittently select different media formats, particularly combinations of video segments and photos. Upon selection of a media format, the camera captures (1106) the specific media format selected. The media may be captured for the predetermined amount of time, as described above.

During media capture, a progress bar is displayed (1108) on a display of the electronic device. The progress bar may indicate how much of a predetermined time period is available for use, as well as the amount of time that has been used. The bar may be continuously updated during media capture. When the progress bar is filled with captured media and the predetermined time of a media recording has been used, media capture may automatically terminate. Alternatively, a user may select when to terminate (1110) media capture. As described above, a photo may take a certain fixed segment of a predetermined time period, for example 1 or 2 seconds, while a video may take the actual time of its duration. The progress bar may differentiate between segments of the predetermined time period that is taken up by a video file and a photo.

Once media capture has been terminated, the media captured, whether only video, only photos, or a combination of the two, is combined (1112) into a single video file. A user may be afforded the opportunity to edit (1114) the combined video, or may be allowed to edit individual captured formats, for example photos and videos forming part of the captured media individually.

When a user is happy with the final combined and edited video file, the user is prompted to provide a description of the video. In the present embodiment, the description may be details of the item that the user is offering for sale. If the item is a motor vehicle, this may be a type of vehicle, details of the usage or ownership history thereof, additional or specific features that the user would like to point out, or the like. This may be provided in a written paragraph, but may also be provided at least partially from drop-down menus where a user may select specific features that may be required to describe the vehicle, for example a region where the seller is located, a year of manufacture of the vehicle, a make or model thereof, or the like as is known in the art. The description is received (1116) by the electronic device.

The electronic device may then generate (1118) tags to be associated with the video. This may be done in a number of ways. A database may be scanned (1120) for pre-existing tags that a user may choose to associate with the video. The database may be stored on the electronic device itself, or may be located at a remote server system, in which case scanning may be performed by the remote server system. If any pre-existing tags correspond to the description provided by the user, these tags may be provided (1122) to the user as suggested tags. Alternatively, users may themselves specify tags, and may be provided with suggested tags already appearing in the database based on tags being completed. This may assist a user in providing tags which is already used on a platform and may assist in correctly categorizing or grouping their item for sale with similar items, thereby allowing a user browsing for such items to locate the new item for sale. Users may be allowed to edit (1124) the tags, or tags may not be editable, typically when selected from lists.

When the tags are finalized, they may be associated (1126) with the video file, and form part of the created video file. The video has then been categorized according to its tags, and may then be displayed in groups consisting of similar tags. The tags may be inserted into a frame of the video, typically a final frame of the video that displays after the video has been viewed. The tags may be in the form of hyperlinks and may be selectable, thereby allowing a person who has viewed the video to select the hyperlink and be directed to other videos with the same tag associated therewith. In the present embodiment, this may be a type of vehicle, price of vehicle, model of vehicle, vehicle from the same location or the like as is known in the art.

It will be apparent that the multimedia file captured using the present method may be incorporated into the display method described and illustrated above with reference to FIGS. 1 to 10. The tags may be displayed in one of the secondary preview sections described above with reference to the same Figures.

The user may be presented with a list of platforms to which they wish the video to be published. The user may input their selected platform, which is received (1128) by the electronic device. After the platforms have been selected, the video may be published (1130) to the selected platforms. It will be apparent that the blockchain-based video platform may be one such platform to which the video may be published. Other users on the platforms may then view the video and interact therewith as is known in the art.

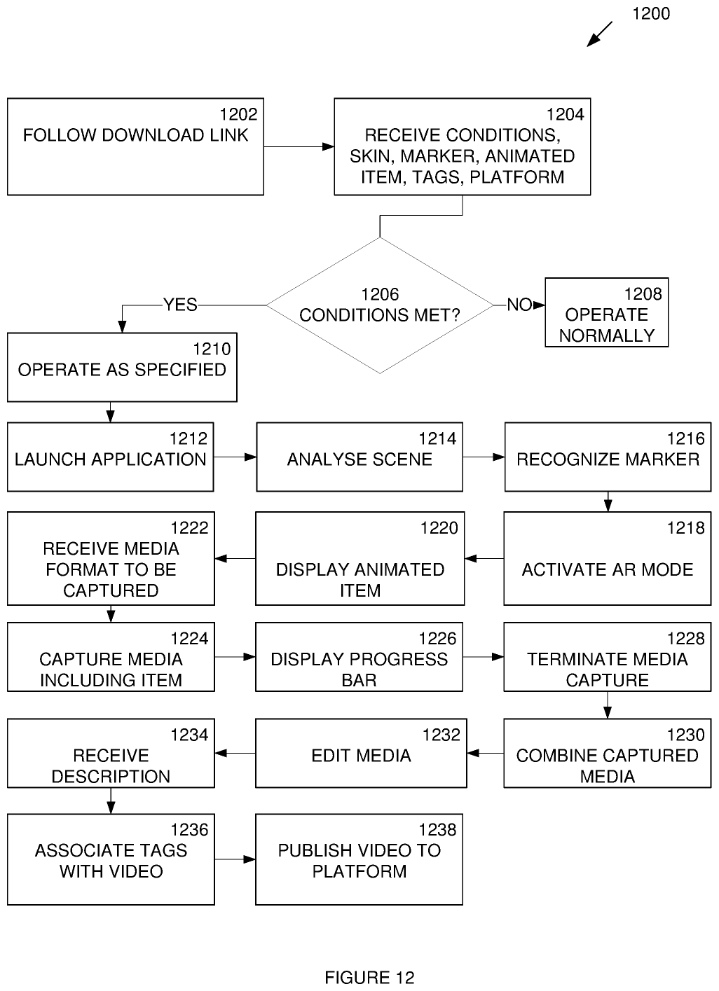

FIG. 12 shows a flow diagram (1200) of a method of operation of an electronic device according to an additional feature of the present invention. In this embodiment, the application is used by an entity sponsoring a festival. The entity may set the application to operate in a desired manner for a specific campaign, presently only when the electronic device is in the geographic location where the festival is held, and also only at times or dates that the festival is active. Approved administrators may be allowed to create and modify campaigns, and custom operation of the application will typically be linked to such a campaign. If a campaign is modified whilst already having been available for download by electronic device, updates made may be automatically pushed through to electronic device using operating the application.

Then, videos captured by user whilst the conditions are met, i.e. while the user is at the festival and while the festival is ongoing, may automatically include tags defined by the entity, for example the name of the festival or of the sponsor. The application may also be configured to, under the correct conditions, publish videos to a predefined platform, possibly to a platform visible only to the entity so that the entity may be allowed to censor videos, or may select videos to be used for advertising purposes. It is envisaged that the videos may be published to a private channel on a platform, for example a private inbox of the entity, so that they may perform desired modifications, inspections or selections before publically publishing approved videos.

A marker may be provided to a user's device, which may in turn scan scenery for the marker. Once the marker has been located, an animated item, also provided to the user's device, may be displayed in a display of the device on the scenery. Capturing of video may then include the animated item. It is envisaged that the marker may be that of a product of the entity, a label or logo, or any selected mark which may identify the entity. The animated item may be a promotional item or mascot of the entity, and may be configured to be displayed next to the marker. However, any location may be desirable. If, for example, the application is configured to recognise shapes, and a shoulder of a person in the display is recognised, the animated item may be configured to be displayed on the shoulder of the person in the scene. It will be apparent to a person skilled in the art that many different augmented reality features are available.

It is envisaged that a skin may be provided to a user which may modify the appearance of the application. This may be that a logo and/or colour scheme of the entity is shown in the application, and may even be that certain functions are not available or are added to the application. When the user is no longer within the location defined by the set conditions, or when the festival is over, the skin may be removed, and the application may revert to a normal appearance or operation mode.

A user follows (1202) a download link associated with a specific campaign on their electronic device. In the present embodiment, the user already has the required application installed on their phone and it is not necessary to download the complete application again. Navigation to the link allows the electronic device to download and receive (1204) conditions, a skin, a marker, an animated item, tags, and platforms to which captured videos may be published, as described above.

The received operating conditions are monitored by the application. If (1206) they are not met, the application may operate (1208) normally. If (1206) they are met, the specified operation mode may be activated (1210). It will be apparent that when the application is downloaded for a specific campaign or event, the application may already apply a downloaded skin and may already limit use of the application prior to the operating conditions being met. This may affirm a user's perception that the application is downloaded for the specific event.

When a user wishes to capture media, they may launch (1212) the application. The application analyses (1214) a scene viewed by a camera of the electronic device and looks for the marker. The scene may be analysed as it is displayed on a preview display of the electronic device. If the marker is recognized (1216), an augmented reality mode is activated (1218). In the augmented reality mode, the animated item is displayed (1220) on the preview display screen. When an input is received (1222) indicating that a user wished to capture media, the media is captured (1224) with the animated item included therein.

A progress bar may again be displayed (1226) and may operate as described above. When media capture is terminated (1228), the captured media may be combined (1230). A user may again be allowed to edit (1232) the media. It is envisaged that the media may be edited before it is combined, or the combined video may be edited.

A user may be allowed to apply a description to the captured video, which is received (1234) by the electronic device. The predetermined tags, received earlier, are then associated (1236) with the video, and the video may be published (1238) to the predetermined platform, also received earlier.

In this manner, an entity may operate a campaign which may enable users to interact with the entity. The entity may obtain videos created by potential customers and may censor and/or edit and/or use the videos if the videos are published to a platform or channel controlled by them.

It will be apparent that the method described above with reference to FIG. 12 may be used in conjunction with the methods described above with reference to FIGS. 1 to 11. Functionality of the methods describe above with reference to FIGS. 11 and 12 may be provided by the video creation component (722) described above with reference to FIG. 7.

Video capture may incorporate augmented reality functionality that does not rely on a marker to generate the desired augmented reality item within the video that is captured. A user may select a specific augmented reality item from a database, and may provide such input via a user interface of the application facilitating such operation. The user may further, in a preview window of the electronic device showing a scene to be captured, provide an indication of where in the video the augmented reality item is to be displayed. The augmented reality item may then be displayed in the preview display at that location, and capturing of the video may include capturing the augmented reality item with the captured media format as it is displayed in the preview display.

Users may be allowed to download augmented reality items to a library on their electronic device, and may also be allowed to import augmented reality items from a native application or gallery directly into the video to be captured. Augmented reality items may be developed by third parties and made available for download or use by users and/or advertisers, who may in turn pay for it. Payment may be done with any suitable currency, including, but not limited to, cryptocurrency usable on the video platform that is employed. Additionally, users may be allowed to upload their own augmented reality models, which may be captured using an appropriate green screen.

The invention may further provide methods and systems for sharing digital content. A user of an electronic device may be provided with at least one selectable category via a user interface of the electronic device. The category may define at least a platform to which an item of digital content is to be published. The platform may be, for example, a messaging platform, a social media platform, an advertising platform, or a website. The item of digital content may be any publishable digital item, for example an image, a video, an audio file such as a voice note, a text message or post containing text. The category may include tags to be added to an item of digital content. The tags may link the item of digital content to a user or group on the platform. This method may be employed to allow a user to publish the same content to multiple platforms, of which one platform may be the blockchain-based video platform described above.

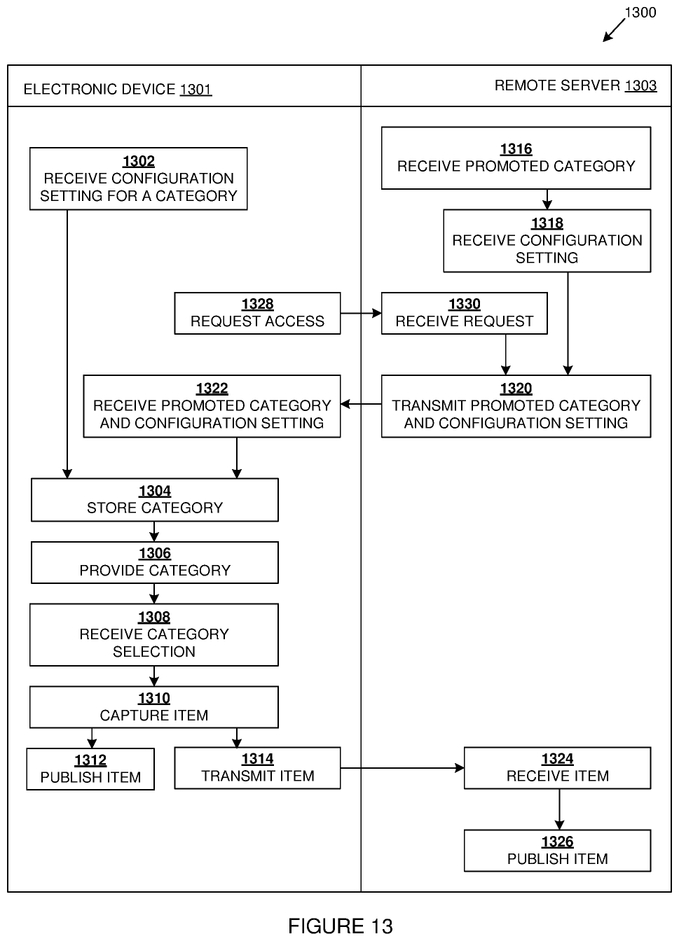

FIG. 13 is a swim lane flow diagram of a method (1300) for sharing digital content according to the present feature of the invention. A mobile application operating on the electronic device (1301) may facilitate operation of this feature of the method (1300), although the method (1300) may be operated through other means on the electronic device (1301) such as a webpage accessible by an appropriate web browser.

The user may configure one or more categories by providing the electronic device (1301) with configuration settings of the one or more categories using a user interface of the electronic device (1301). The configuration settings may include a platform to which an item of digital content is to be published and a tag to be added to the item of digital content. The configuration settings provided by the user is received (1302) at the electronic device (1301) and the configured category is stored (1304) in a memory of the electronic device. At a later stage, the user is provided (1306) with at least one selectable category via the interface of the electronic device (1301). As mentioned previously, each category defines a platform to which the item of digital content is to be published. The user selects a category provided via the interface and the selected category is received (1308) at the electronic device (1301). An item of digital content, typically a video, which the user wishes to publish is captured (1310) by the electronic device (1301) or alternatively selected by the user and is published (1312) on the platform defined by the selected category. The item of digital content may additionally or alternatively be transmitted (1314) to the remote server for further publishing (1326).

The platform to which an item of digital content is to be published may be the blockchain-based video platform described above, and the item of digital content that the user wishes to publish may be a video. The user may configure a category by providing the electronic device with configuration settings of the category using the user interface of the electronic device. The configuration settings includes the platform to which the video is to be published and a tag to be added to the video. The tag to be added to the video may link the video to a user or group on the platform. The user, at a later stage, is provided with the category for selection via the interface of the electronic device (1301). The user may select the category and the selected category is received at the electronic device (1301). The video that the user wishes to publish is captured by the electronic device (1301) in any known manner, possibly in one of the method described above. The video may alternatively be selected by the user by retrieving the video from an existing library of the electronic device (1301), for example, a video gallery. The video is then published on the platform and/or transmitted to the remote server for further publishing by the remote server. Other users on the platform may then view the video and interact therewith as is known in the art and as described above.

A category, in this case a promoted category, may have previously been configured by an external party. Each promoted category may be associated with a campaign managed by the external party and may include details of the campaign such as the title of the campaign, an advertisement, a news trend, or a sale. Each promoted category defines a set of conditions defining when the promoted category is available for selection by the user of the electronic device. The set of conditions may include, for example, that the time of day or date falls within a specific time period, that the electronic device is in a specific geographical area, or that a specific physical use of the device has occurred. Each promoted category includes a platform to which the item of digital content may be published and/or a tag which is to be added to a captured item of digital content.

The promoted category and configuration settings of the promoted category may be received (1316, 1318) at the remote server (1303) and transmitted (1320) to the electronic device (1301) of the user. In this case, the remote server (1303) is associated with the external party. The configuration settings of the promoted category may include a thumbnail image associated with the promoted category. The promoted category and configuration settings transmitted by the remote server (1303) is received (1322) at the electronic device (1301) and stored (1304) in a memory of the electronic device (1301). At a later stage, the user is provided (1306) with at least one selectable category via the interface of the electronic device (1301). The at least one selectable category includes the promoted category if the set of conditions defining when the promoted category is available for selection by the user of the electronic device is met. The user selects a promoted category provided via the interface and the selected category is received (1308) at the electronic device (1301). An item of digital content which the user wishes to publish is captured (1310) by the electronic device (1301) or alternatively selected by the user and is transmitted (1314) to the remote server (1303). The item of digital content is received (1324) at the remote server (1303) and published (1326) on the platform defined by the selected category.

A user may alternatively request (1328) access to a campaign from the electronic device prior to the remote server (1303) transmitting the promoted category and configuration settings of the promoted category to the electronic device (1301) of the user. The request for access is received (1330) at the remote server (1303) and the remote server transmits (1320) the promoted category and configuration settings of the promoted category to the electronic device (1301) of the user.

In an exemplary embodiment, the campaign is a sale, the set of conditions defining when the promoted category is available for selection by the user of the electronic device is that the date falls within a specific time period, e.g. from the 1st day to 5th day of every month and that the electronic device is in a specific geographical area e.g. in Cape Town South Africa, the platform to which an item of digital content is to be published is an advertising platform, and the item of digital content which the user wishes to publish is a post containing text.

An external party e.g. a manager of a sales campaign may configure a promoted category which is received at a remoted server associated with the external party together with configuration settings of the promoted category. The configuration settings include a thumbnail image for the promoted category, and the promoted category includes the set of conditions and platform as defined above. The promoted category and configuration settings of the promoted category is transmitted to the electronic device of the user. The promoted category and configuration settings is received at the electronic device and stored in a memory of the electronic device. At a later stage, the user is provided with the promoted category for selection via the interface of the electronic device, if the set of conditions defining when the promoted category is available for selection by the user of the electronic device is met, for example, if it is the 1 of Feb. 2017 and the electronic device is located in Cape Town South Africa. The user may wish to partake in the sales campaign and may select the promoted category which is then received at the electronic device. A post containing text which the user wishes to publish is captured by the electronic device and is then transmitted to the remote server for publishing by the remote server. The post containing text may be a request to purchase an item on sale. The external party may then view a post containing text and interact therewith as is known in the art. The user may alternatively request for access to the sales campaign by transmitting a request to the remote server for access to the sales campaign.

In another exemplary embodiment, the campaign is a news trend, the set of conditions defining when the promoted category is available for selection by the user of the electronic device is that the electronic device is in a specific geographical area e.g. in Johannesburg, South Africa, the platform to which an item of digital content is to be published is a website, and the item of digital content which the user wishes to publish is a post containing text.

An external party e.g. an administrator of a website may configure a promoted category which is received at a remoted server associated with the external party together with configuration settings of the promoted category. The promoted category and configuration settings of the promoted category is transmitted to the electronic device of the user. The promoted category and configuration settings is received at the electronic device and stored in a memory of the electronic device. The user is provided with the promoted category for selection if the set of conditions is met, for example, if the electronic device is located in Johannesburg, South Africa. The user may wish to provide information on a particular news trend occurring in that location and may select the promoted category which is then received at the electronic device. A post containing text which the user wishes to publish is captured by the electronic device and is then transmitted to the remote server for publishing by the remote server. The external party may then view post containing text and interact therewith as is known in the art.

It will be appreciated that by preconfiguring categories with platforms to which items of digital content may be published, a user is able to save time when publishing content, as the content is automatically published on all the platforms of a selected category.

It should be noted that the above feature of the invention may be combined with methods described above, particularly if the blockchain-based video platform is one of the chosen platforms to which the video is to be published. This feature may precede the steps of other methods described above with reference to FIGS. 1 to 12 above.

The publishing platform selection component (724) described above with reference to FIG. 7 may provide the functionality of the method described with reference to FIG. 13.

FIG. 14 illustrates an example of an electronic device (1400) in which various aspects of the disclosure may be implemented. The electronic device (1400) may be embodied as any form of data processing device including a personal electronic device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the electronic device may dictate the inclusion or exclusion of various components or subsystems described below.

The electronic device (1400) may be suitable for storing and executing computer program code. The various participants and elements in the previously described system diagrams may use any suitable number of subsystems or components of the electronic device (1400) to facilitate the functions described herein. The electronic device (1400) may include subsystems or components interconnected via a communication infrastructure (1405) (for example, a communications bus, a network, etc.). The electronic device (1400) may include one or more processors (1410) and at least one memory component in the form of computer-readable media. The one or more processors (1410) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the electronic device (1400) may be distributed over a number of physical locations (e.g. in a distributed, cluster or cloud-based computing configuration) and appropriate software units may be arranged to manage and/or process data on behalf of remote devices.

The memory components may include system memory (1415), which may include read only memory (ROM) and random access memory (RAM). A basic input/output system (BIOS) may be stored in ROM. System software may be stored in the system memory (1415) including operating system software. The memory components may also include secondary memory (1420). The secondary memory (1420) may include a fixed disk (1421), such as a hard disk drive, and, optionally, one or more storage interfaces (1422) for interfacing with storage components (1423), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The electronic device (1400) may include an external communications interface (1430) for operation of the electronic device (1400) in a networked environment enabling transfer of data between multiple electronic devices (1400) and/or the Internet. Data transferred via the external communications interface (1430) may be in the form of signals, which may be electronic, electromagnetic, optical, radio, or other types of signal. The external communications interface (1430) may enable communication of data between the electronic device (1400) and other electronic devices including servers and external storage facilities. Web services may be accessible by and/or from the electronic device (1400) via the communications interface (1430).

The external communications interface (1430) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuity. The external communications interface (1430) may include a subscriber identity module (SIM) in the form of an integrated circuit that stores an international mobile subscriber identity and the related key used to identify and authenticate a subscriber using the electronic device (1400). One or more subscriber identity modules may be removable from or embedded in the electronic device (1400).

The computer-readable media in the form of the various memory components may provide storage of computer-executable instructions, data structures, program modules, software units and other data. A computer program product may be provided by a computer-readable medium having stored computer-readable program code executable by the central processor (1410). A computer program product may be provided by a non-transient computer-readable medium, or may be provided via a signal or other transient means via the communications interface (1430).

Interconnection via the communication infrastructure (1405) allows the one or more processors (1410) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the electronic device (1400) either directly or via an I/O controller (1435). One or more displays (1445) (which may be touch-sensitive displays) may be coupled to or integrally formed with the electronic device (1400) via a display (1445) or video adapter (1440).

The electronic device (1400) may include a geographical location element (1455) which is arranged to determine the geographical location of the electronic device (1400). The geographical location element (1455) may for example be implemented by way of a global positioning system (GPS), or similar, receiver module. In some implementations the geographical location element (1455) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the electronic device (1400). In some implementations, the geographical location element (1455) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method performed on an electronic device, the method comprising the steps of:
providing a playback region on a display associated with the electronic device;
providing a preview screen in the playback region prior to or after playback of a primary video, the playback region being divided into multiple secondary preview sections, each preview section being selectable and representing a link;
providing a play button associated with the primary video;
responsive to receiving a selection of the play button, playing the primary video; and
responsive to receiving a selection of a secondary preview section, navigating to the link of the secondary preview section.

2. The method as claimed in claim 1, wherein the playback region fills the entire display of the electronic device.

3. The method as claimed in claim 1, wherein the display is a user interface of the electronic device.

4. The method as claimed in claim 1, wherein the number of secondary preview sections is six.

5. The method as claimed in claim 1, further including the step of, responsive to selection of a secondary preview section representing a link to a further video, displaying the further video in the playback region.

6. The method as claimed in claim 1, wherein the display is a touch-sensitive display of the electronic device, and a selection from a user is received via the touch-sensitive display.

7. The method as claimed in claim 1, wherein the link is selected from the list comprising: a link to a video captured at the same location or of the same scene as the primary video and with a different camera; a link to a list of videos associated with a same user profile as that of a user profile associated with the primary video; a link to a list of videos associated with the primary video due to a related genre or location; a link to individual frames or photos forming part of the primary video or being associated with the primary video; a link to a location associated with the primary video; a link to a website associated with the primary video; a link to advertising content associated with the primary video; and a link to a tag associated with the primary video.

8. The method as claimed in claim 1, wherein the primary video has a location associated therewith, the location being associated with or owned by a digital land owner.

9. The method as claimed in claim 1, further including the steps of capturing a primary video; receiving, from the user, an indication of a genre of the captured video; recording a geo-location at which the video is captured; receiving, from the user, tags to be associated with the primary video; and receiving, from the user, an indication of the secondary preview sections to be shown before or after playback of the primary video.

10. The method as claimed in claim 9, wherein the step of receiving an indication of the secondary preview sections to be shown before or after playback of the primary video includes the user selecting any one or more advertisers or group of advertisers allowed to advertise in any one or more of the secondary preview sections.

11. The method as claimed in claim 10, wherein a list of advertisers from which a user selects advertisers is filtered based on advertiser input in the form of an indication of genres of videos, geo-locations of videos, or users the advertisers wish to advertise with or to.

12. The method as claimed in claim 1, further including the steps of receiving, from a user, a selection of a media format to be captured; capturing, using a camera associated with the electronic device, the selected media format; combining all formats of captured media into a video file; associating tags with the video file, the tags describing features of the video file and enabling categorization of video files having shared associated tags at a media platform; and publishing the video file to the media platform.

13. The method as claimed in claim 1, further including the steps of providing a user of the electronic device with at least one selectable category, the category defining at least a platform to which a video file is to be published; receiving a selection of a category from the user via a user interface of the electronic device; capturing an item of digital content which the user wishes to publish; and publishing the video file on the platform defined by the selected category.

14. A system for navigating in a digital environment comprising an electronic device including a memory for storing computer-readable program code and a processor for executing the computer-readable program code having:
a playback region component for providing a playback region on a display associated with the electronic device;
a preview screen component for providing a preview screen in the playback region prior to or after playback of a primary video,
a play button component for providing a play button associated with a primary video in the playback region,
a preview section component for dividing the playback region into multiple secondary preview sections, each preview section being selectable and representing a link;
a playback component for, responsive to receiving a selection of the play button, playing the primary video; and
a navigation component for, responsive to receiving a selection of a secondary preview section, navigating to the link of the secondary preview section.

15. A computer program product comprising a non-transient computer-readable medium having stored computer-readable program code for performing the steps of:
providing a playback region on a display associated with the electronic device;
providing a preview screen in the playback region prior to or after playback of a primary video, the playback region being divided into multiple secondary preview sections, each preview section being selectable and representing a link;
providing a play button associated with the primary video;
responsive to receiving a selection of the play button, playing the primary video; and
responsive to receiving a selection of a secondary preview section, navigating to the link of the secondary preview section.
